(19) United States
(12) Patent Application Publication
(10) Pub. No.: US 2007/0039291 A1
(43) Pub. Date: Feb. 22, 2007

(54) Dust collecting apparatus for vacuum cleaner

(75) Inventors: Ji-Won Seo, Gwangju-City (KR); Jang-Keun Oh, Gwangju-City (KR)

Correspondence Address: Paul D. Greeley;Ohlandt, Greeley, Ruggiero & Perle, L.L.P., 10th Floor, One Landmark Square, Stamford, CT, 06901-2682, US

(73) Assignee: SAMSUNG GWANGJU ELECTRONICS CO., LTD.

(21) Appl. No.: 11/386,470

(22) Filed: Mar. 22, 2006

(30) Foreign Application Priority Data
Aug. 16, 2005 (KR) 10-2005-0074954

(51) Int. Cl. B01D 50/00

(52) U.S. Cl. 55/319

(57) ABSTRACT

A dust collecting apparatus having a main body, a grill member, and a guide member is provided. The main body is connected to a suction passage and a discharge passage of the vacuum cleaner. The grill member provides an outlet for filtering the air discharged from the main body. The guide member extends from the grill member and faces an inlet of the main body. The guide member converts rapidly a flow direction of the air entering the main body through the suction passage to separate moisture from the air.

### CROSS-REFERENCE TO RELATED APPLICATIONS

This application claims benefit under 35 U.S.C. § 119 (a) of Korean Patent Application No. 2005-74954, filed Aug. 16, 2005 in the Korean Intellectual Property Office, the entire contents of which are incorporated herein by reference.

### BACKGROUND OF THE INVENTION

1. Field of the Invention

The present invention relates to a vacuum cleaner. More particularly, the present invention relates to a dust collecting apparatus for a vacuum cleaner, which separates contaminant from air sucked from a surface to be cleaned.

2. Description of the Related Art

In general, a vacuum cleaner is an apparatus which sucks air containing dust or contaminant from a surface to be cleaned using a suction force produced by driving a motor and separates the dust or contaminant from the sucked air and collects the dust or contaminant using a dust collecting apparatus. Mostly, the vacuum cleaner can effectively clean dry dust, but if the sucked air contains moisture, the motor of the vacuum cleaner can be damaged by the moisture.

In order to solve the above problem and to clean the area contaminated with moisture and dust using a wet cleaning method, the vacuum cleaner provided with a moisture separating apparatus has been developed. Such moisture separating apparatus can separate moisture from the sucked air and is replaceably mounted in the vacuum cleaner. However, such conventional vacuum cleaner is inconvenient for use. When a user wants to convert a dry cleaning mode into a wet cleaning mode, the user must detach the dust separating apparatus and then mount the moisture separating apparatus in the vacuum cleaner. Additionally, when the user replaces the dust separating apparatus with the moisture separating apparatus and vice versa, it is unsanitary to grip the contaminated dust separating apparatus and the moisture separating apparatus by hands.

### SUMMARY OF THE INVENTION

An aspect of the present invention is to solve at least the above problems and/or disadvantages and to provide at least the advantages described below. Accordingly, an aspect of the present invention is to provide a dust collecting apparatus in the vacuum cleaner, which can be used easily and can clean sanitarily in wet and dry manners.

Another aspect of the present invention is to provide a dust collecting apparatus, which has enhanced moisture-collection efficiency and is applicable to the vacuum cleaner being able to clean in wet and dry methods.

Yet another aspect of the present invention is to a dust collecting apparatus, which can inhibit moisture from re-scattering and is applicable to the vacuum cleaner being able to clean in wet and dry methods.

According to one embodiment proposed to achieve the above-described aspect, there is provided the dust collecting apparatus formed in a cleaner having a suction assembly sucking air and contaminant around a place to be cleaned and separating contaminant from the sucked air, comprising a main body having an inlet in fluid communication with the suction assembly and an outlet in fluid communication with a discharge passage of the cleaner, the main body separating dust from the sucked air flowing through the inlet and discharging the air through the outlet; a grill member formed at the outlet for filtering the air discharged from the main body; and a guide member formed at a lower end of the grill member to face to the inlet, the guide member changing rapidly a flow direction of the air flowing in the main body through the suction passage to separate moisture from the air.

It is preferable that the guide member is integrally formed with the grill member.

Further, the main body may have a dust collecting case having an opened side end and accumulating the dust separated from the sucked air and a cover for opening and closing the opened upper end of the dust collecting case. Also, it is preferable that the inlet be formed at one end of a suction tube that penetrates a portion of the dust collecting case and extends to an inside of the dust collecting case located at an upper side of the suction assembly, and the outlet is penetratingly formed on the cover.

Also, it is preferable that the outlet, the inlet, the grill member, and the guide member are coaxially disposed in the main body.

In addition, the grill member has a discharge tube formed integrally therewith. The discharge tube penetrates the outlet and is in fluid communication with the discharge passage. The grill member is provided at a center of upper side of the main body.

Further, the guide member may comprise a shield plate provided at a side of the grill member facing the inlet and spaced apart from the inlet at a certain distance to block the inlet for changing a flow direction of the air sucked in the dust collecting case through the inlet; and a skirt cylindrically shaped and extended from the shield plate to the inlet. Also, it is preferable that an upper end of the suction tube is spaced apart from and surrounded by a lower part of the skirt so that a flow direction of the air flowing from the inlet changes by the shield plate and the air then flows to an inside of the dust collecting case through a first space formed between an inner wall of the skirt and an outer wall of the suction tube.

It is preferable that a diameter of the shield plate is 80% or less of an inner diameter of the main body.

The skirt may have an upper end portion connected to the grill member and a lower end portion surrounding an upper end of the suction tube, and an inner diameter of the skirt is gradually reduced toward the upper end portion.

Also, it is preferable that the skirt has an inner diameter, which is gradually reduced toward the lower end portion.

In addition, it is preferable that the skirt has an inner diameter, which is gradually increased toward the lower end portion.

It is preferable that the skirt has an upper end portion connected to the grill member and a lower end portion surrounding an upper end of the suction tube, and an inner diameter of the skirt is gradually reduced toward the lower end portion.

Further, the skirt may comprise an upper end portion connected to the grill member and a lower end portion surrounding an upper end of the suction tube, the skirt can be formed such that an inner diameter of the skirt is gradually increased toward the lower end portion.

### BRIEF DESCRIPTION OF THE DRAWING FIGURES

The above aspect and other features of the present invention will become more apparent by describing in detail exemplary embodiments thereof with reference to the attached drawing figures, wherein;

FIG. 1 is a sectional view showing the dust collecting apparatus according to a first embodiment of the present invention;

FIG. 2 is an exploded perspective view of the dust collecting apparatus in FIG. 1;

FIG. 3 is a sectional view showing the dust collecting apparatus according to a second embodiment of the present invention;

FIG. 4 is a sectional view showing the dust collecting apparatus according to a third embodiment of the present invention;

FIG. 5 is a sectional view showing the dust collecting apparatus according to a fourth embodiment of the present invention; and

FIG. 6 is a sectional view showing the dust collecting apparatus according to a fifth embodiment of the present invention.

### DETAILED DESCRIPTION OF THE EXEMPLARY EMBODIMENTS

Hereinafter, a dust collecting apparatus of the vacuum cleaner according to the embodiments of the present invention will be described in detail with reference to the accompanying drawing figures.

In the following description, same drawing reference numerals are used for the same elements even in different drawings. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

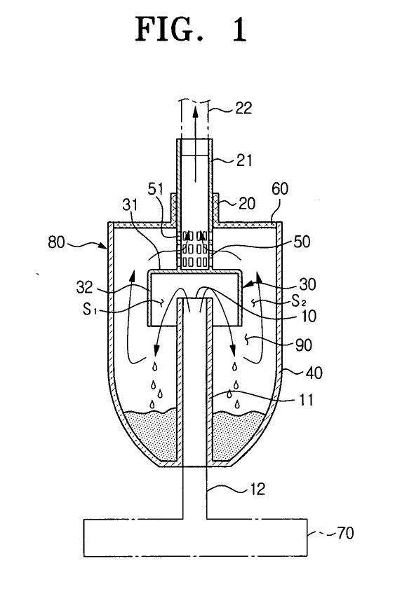

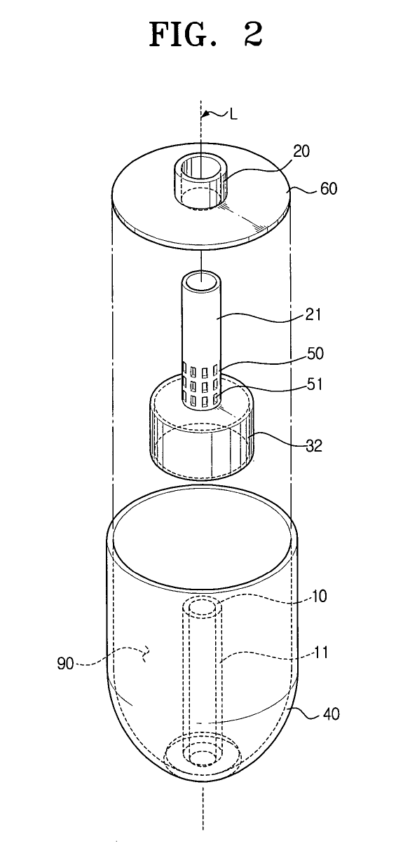

Referring to FIG. 1 and FIG. 2, a dust collecting apparatus according to the first embodiment of the present invention comprises a main body 80, a grill member 50 and a guide member 30.

The main body 80 is provided between a suction flow passage 12 coupled with a suction assembly 70 and a discharge flow passage 22 connected to an exterior of the vacuum cleaner (not shown), contaminant separated from air sucked through the suction assembly 70 is received in the main body 80. To this end, the main body 80 of the dust collecting apparatus is provided with a contaminant collecting case 40 and a cover 60. The contaminant collecting case 40 comprises a dust collecting chamber 90, a suction tube 11, and an inlet 10. The dust collecting chamber 90 is a space in which the contaminant separated from the sucked air is accumulated, this dust collecting chamber is formed in the dust collecting case 40. The suction tube 11 is connected to the suction flow passage 12 and protruded from a bottom surface of the dust collecting case 40 toward the dust collecting chamber 90 by a certain length so that the sucked air is guided to the dust collecting chamber 90. The suction tube 11 is formed integrally with the dust collecting case 40. The inlet 10 is formed at an upper end of the suction tube 11 so that the inlet is in the dust collecting chamber 90. The cover 60 can be selectively opened or closed to provide a cover for an opened upper end of the dust collecting case 40. The cover 60 includes a tubular shaped outlet 20 formed at a center of the cover 60.

The grill member 50 is provided for filtering the air discharged from the main body 80 toward the discharge flow passage 22. To this end, the grill member 50 protrudes from a lower side of the cover 60 so that the grill member 50 is installed at a central portion of an upper end of the main body 80. It has been determined that some of the moisture collected in the dust case can be scattered again along an inner wall of the main body 80 by a suction force of the vacuum cleaner. The grill member 50 is placed at a central portion of upper end of the main body 80 so that the moisture has difficulty accessing the grill member. In this manner, it is possible to prevent the moisture from discharging to the outlet 20. For reference, a discharge tube 21 is formed integrally with an upper end of the grill member 50, the discharge tube 21 is press-fitted to the outlet 20 formed on the cover 60 so that the discharge tube 21 is in fluid communication with the discharge flow passage 22.

The guide member 30 converts a flow direction of air sucked in the dust collecting chamber 90 and condenses moisture so that the moisture is separated from the sucked air. To this end, the guide member 30 comprises a shield plate 31 and a skirt 32.

The shield plate 31 is formed at a lower end of the grill member 50 so that the shield plate 30 faces and is spaced apart from the inlet 30 by a certain distance. The skirt 32 is extends from the shield plate 31 such that the moisture condenses on the shield plate 31 and the drops by a self weight into the dust collecting chamber 90. To this end, in this embodiment, the skirt 32 extends downward from a periphery of the shield plate 31 in the shape of a cylinder. At this time, a portion of a lower end of an inner wall of the skirt 32 is spaced apart from a portion of an upper end of an outer wall of the suction tube 11 at a certain distance so that a first space S1 is formed to allow the sucked air to enter the dust collecting chamber 90. Additionally, in order to guide the moisture-removed air through the first space S1 to the grill member 50, a second space S2 is formed between an outer wall of the skirt 32 and an inner wall of the dust collecting case 40.

For reference, in this embodiment, the inlet 10, the outlet 20, the grill member 50 and the guide member 30 are disposed coaxially on one line L. Accordingly, a structure of the dust collecting apparatus becomes simple and it is possible to easily assemble the apparatus.

On the other hand, in this embodiment, the shape of the skirt 32 is described to be extended downward from a periphery of the shield plate 31. However, a diameter of the skirt 32 can be made smaller than that of the shield plate 31.

The flow path of the air according to the dust collecting apparatus of the present invention is described below with reference to FIG. 1.

The air sucked from a surface to be cleaned through the suction assembly 70 is guided to the main body 80 via the suction flow passage 12 and the suction tube 11 and through inlet 10.

Once the guided air collides against the shield plate 31 facing the inlet 10, a flow direction of the air is converted and moisture contained in the air is condensed on the shield plate 31. After a flow direction of the air is converted by the shield plate 31, a flow of the air is converted again by the skirt 32, and the air enters the main body 80 through the first space S1 between the inner wall of the skirt 32 and the outer wall of the suction tube 11. At this time, once a size of moisture condensed on a lower surface of the shield plate 31 becomes larger than a certain size, the moisture falls along the inner wall of the skirt 32 and then is collected in the dust collecting case 40. As described above, the air from which moisture is separated is transferred to the grill member 50 through the second space S2 formed between the outer wall of the skirt 32 and the inner wall of the dust collecting case 40. The air from which moisture is separated then enters the grill member 50 through micro holes 51 of the grill member 50. Due to such process, the contaminant contained in the air is separated from the air, the air is then guided sequentially in the discharge tube 21 and the discharge flow passage 22 to discharge to an exterior.

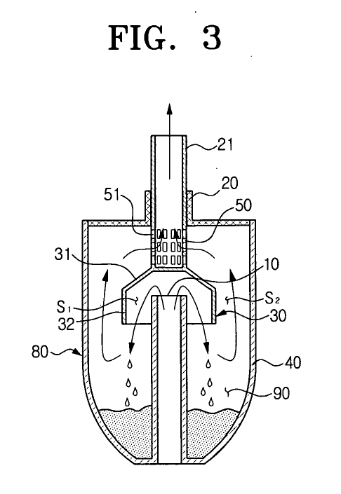

It has been determined that the moisture separation effect as described above is enhanced in proportion to the size of the shield plate 31. Thus, the larger the shield plate 31, the more moisture that can be separated from the air. However, once the second space S2 is too narrow due to the shield plate 31 having a larger size than a certain size, a pressure loss is increased so that a suction force of the vacuum cleaner becomes lower and a damage of the motor can be caused. In consideration of the above aspect, it has been determined that it is preferable to limit a diameter of the shield plate 31 to 80% or less of an inner diameter of the main body 80 of the dust collecting apparatus. In this case, if the skirt 32 is satisfied with the above conditions, unlike the first embodiment, the skirt can be changed to the various shapes in order to enhance the moisture separation efficiency or reduce the pressure loss. Such examples are shown in FIG. 3 to FIG. 6.

According to the second embodiment of the present invention, as shown in FIG. 3, the skirt 32 is formed such that an inner diameter of the skirt coupled with the grill member 50 is gradually reduced toward an upper end so as to reduce a pressure loss and increase a suction force of the dust collecting apparatus. Due to such shape, the second space S2 is gradually enlarged along a flow direction of the air so that a flow of the air becomes ease at the outlet.

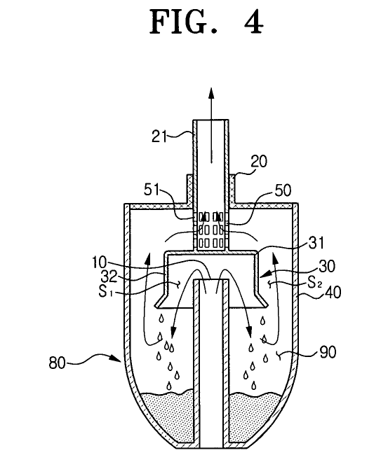

According to the third embodiment of the present invention, as shown in FIG. 4, the skirt 32 is formed such that an inner diameter of the skirt 32 is gradually increased toward a lower end so as to enhance a capability for collecting moisture in the dust collecting case 40. Due to such shape, it is possible to prevent moisture condensed by the shield plate 31 and free fallen along the inner wall surface of the skirt 32 from being risen to the discharge tube 21 along the outer wall surface of the skirts 32.

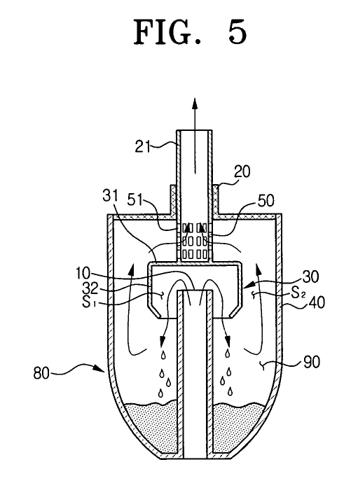

According to the fourth embodiment of the present invention, as shown in FIG. 5, the skirt 32 is formed such that an inner diameter of the skirt is gradually reduced toward a lower end of the skirt 32. Due to such shape, the first space S1 is gradually reduced along a flow direction of the air, and so a flow rate of the air is increased to enhance a suction capability.

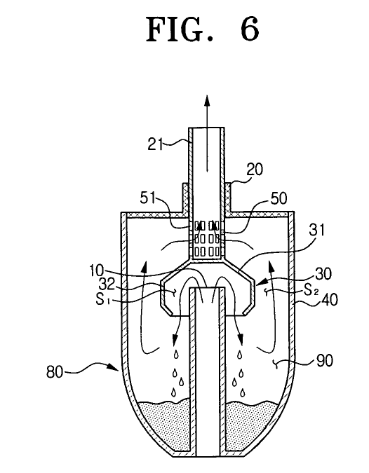

On the other hand, a shape of the skirt 32 is not limited to only the shapes described in the second, third and fourth embodiments. For one example, in the fifth embodiment of the present invention, as shown in FIG. 6, the skirt 32 is formed in the form of a combination of the shape in the second embodiment and the shape in the fourth embodiment to enable to reduce a pressure loss and enhance the moisture separation efficiency.

In addition, although not shown in the drawing, It goes without saying that the skirt 32 can be formed in the form of a combination of the shape in the second embodiment and the shape in the third embodiment

In the dust collecting apparatus according to the present invention as described above, the guide member can be formed integrally with the grill member as one body.

By using the dust collecting apparatus according to the embodiments of the present invention, there is no need to replace the structural element for cleaning in the wet manner and the dry manner, and so the vacuum cleaner is conveniently used. Also, since the user does not have to handle the structural element receiving the contaminant with the hand, the user can use sanitarily the vacuum cleaner.

Also, in the dust collecting apparatus according to the embodiments of the present invention, since the grill member is provided at an upper side of center of the main body to which the moisture is most difficult of access, the moisture-collection efficiency is enhanced. In addition, since it is possible to inhibit moisture from re-scattering of moisture, a damage of the motor can be prevented.

Further, in the dust collecting apparatus according to the embodiments of the present invention, the guide member is formed integrally with the grill member, and so the grill member, the dust collecting case and the cover can be easily separated from the dust collecting apparatus after the cover is opened. Consequently, the dust collecting apparatus can be conveniently cleaned.

While the invention has been shown and described with reference to certain embodiments thereof, it will be understood by those skilled in the art that various changes in form and details may be made therein without departing from the spirit and scope of the invention as defined by the appended claims.

What is claimed is:

1. A dust collecting apparatus for use in a cleaner having a suction assembly sucking air, comprising:
a main body having an inlet in fluid communication with the suction assembly and an outlet in fluid communication with a discharge passage of the cleaner, the main body separating contaminant from the sucked air flowing through the inlet and discharging the air through the outlet;
a grill member formed at the outlet for filtering the air discharged from the main body; and
a guide member formed at a lower end of the grill member to face to the inlet, the guide member changing rapidly a flow direction of the air flowing in the main body through the suction passage to separate moisture from the air.

2. The dust collecting apparatus of claim 1, wherein the guide member is integrally formed with the grill member.

3. The dust collecting apparatus of claim 1, wherein the main body comprises a dust collecting case having an opened side end and accumulating the dust separated from the sucked air and a cover for opening and closing the opened upper end of the dust collecting case,
the inlet is formed at one end of a suction tube which penetrates a portion of the dust collecting case and extends to an inside of the dust collecting case located at an upper side of the suction assembly, and
the outlet is penetratingly formed on the cover.

4. The dust collecting apparatus of claim 1, wherein the outlet, the inlet, the grill member, and the guide member are coaxially disposed in the main body.

5. The dust collecting apparatus of claim 3, wherein the grill member has a discharge tube formed integrally therewith, the discharge tube penetrates the outlet and is communicated with the discharge passage, and the grill member is provided at a center of upper side of the main body.

6. The dust collecting apparatus of claim 3, wherein the guide member comprises:
a shield plate provided at a side of the grill member facing the inlet and spaced apart from the inlet at a certain distance to block the inlet for changing a flow direction of the air sucked in the dust collecting case through the inlet; and a skirt cylindrically shaped and extended from the shield plate to the inlet; and
an upper end of the suction tube spaced apart from and surrounded by a lower part of the skirt so that the flow direction of the air flowing from the inlet changes by the shield plate and the air then flows in an inside of the dust collecting case through a first space formed between an inner wall of the skirt and an outer wall of the suction tube.

7. The dust collecting apparatus of claim 6, wherein the shield plate has a diameter that is 80% or less of an inner diameter of the main body.

8. The dust collecting apparatus of claim 6, wherein the skirt has an upper end portion connected to the grill member and a lower end portion surrounding an upper end of the suction tube, and an inner diameter of the cylindrical shaped skirt is gradually reduced toward the upper end portion.

9. The dust collecting apparatus of claim 8, wherein the skirt has an inner diameter that is gradually reduced toward the lower end portion.

10. The dust collecting apparatus of claim 8, wherein the skirt has an inner diameter that is gradually increased toward the lower end portion.

11. The dust collecting apparatus of claim 6, wherein the skirt has an upper end portion connected to the grill member and a lower end portion surrounding an upper end of the suction tube, and an inner diameter of the skirt is gradually reduced toward the lower end portion.

12. The dust collecting apparatus of claim 6, wherein the skirt comprises an upper end portion connected to the grill member and a lower end portion surrounding an upper end of the suction tube, and an inner diameter of the skirt is gradually increased toward the lower end portion.
